(19) United States
(12) Patent Application Publication
(10) Pub. No.: US 2022/0034382 A1
(43) Pub. Date: Feb. 3, 2022

(54) Hybrid Impact Passive Energy Absorber

(71) Applicant: Massachusetts Institute of Technology, Cambridge, MA (US)

(72) Inventor: Maor Farid, Brighton, MA (US)

(21) Appl. No.: 16/942,044

(22) Filed: Jul. 29, 2020

(51) Int. Cl. F16F 15/04; F16F 15/02

(52) U.S. Cl. CPC F16F 15/04; F16F 2232/08; F16F 2238/026; F16F 15/022

(57) ABSTRACT

A hybrid impact passive energy absorber has a rigid housing with a mounting base. A housing body includes an interior chamber formed around a chamber axis spanning between two ends of the body. A chamber central portion is partially bounded by first and second central chamber walls. A first chamber end portion extends from the body first end and the first central chamber wall, and a second chamber end portion extends from the body second end and the second central chamber wall. A shaft is disposed within the housing chamber along the chamber axis between the housing first and second ends. An internal mass within the chamber central portion slides on the shaft passing through an internal mass central bore. First and second helical springs surround the shaft on either side of the internal mass, abutting both the chamber end and the internal mass.

### FIELD OF THE INVENTION

The present invention relates to an energy transfer device, and in particular to a passive hybrid impact passive energy absorber.

### BACKGROUND OF THE INVENTION

When subjected to external loadings and disturbances, engineering systems from various fields and industries are exposed to destructive vibration, for example in the aviation, space, naval, chemical, nuclear, and automotive industries. Existing vibration mitigation solutions include suspensions, active and passive vibration mitigation methods. Passive energy absorbers (PEAs) operate by channeling the undesired vibration energy from a main system to a smaller PEA attached to the main system. The PEA converts the energy to heat via friction. PEAs are known effective and reliable for destructive vibration prevention under various excitation types, such as impulsive, periodic, and stochastic loading. However, current PEA models suffer from a mutual shortcoming of effectiveness only in a limited energy range.

During their life-time, structures or mechanical systems are typically exposed to undesired vibration due to their functionality (for example rotating systems, motored machinery) and external disturbances (such as wind, seismic excitation) which can lead to destructive consequences. Passive energy absorbers (PEAs) have been attempted as a solution. For example, a PEA may be a relatively small attachment to the primary structure of interest that passively absorbs the undesired and potentially hazardous energy. Various PEA designs and concepts have been attempted, generally classified in two groups: tuned mass dampers (TMDs) and the nonlinear energy sinks (NESs). A TMD is a linear system, and hence is effective only when the primary structure (PS) is vibration very near its natural frequency, i.e. its effective only for a small frequency range.

Moreover, their nonlinear and more sophisticated design allows NES to be more compact with respect to the TMDs. However, the NES designs suffer from a common shortcoming of effectiveness for merely high intensity vibration. When the PS perform small amplitude oscillations, the nonlinearity of the NES cannot come into play and as a result the NES does not perform significant oscillations and absorb the undesired energy from the PS into the NES. For example, the rotational NES can rotate in the plane of excitation around a vertical axis. Here, the NES performs well when the PS performs intensive vibration and manages to mitigate its vibration. However, for lower vibration intensities the rotational mass does not manage to perform rotations and hence only a low portion of the energy is absorbed into the rotational PEA.

Most PEA designs have been effective up to a maximal vibration intensity, which is referred to in herein as moderate energy intensity. When the applied vibration intensity exceeds moderate energy intensity (referred to herein as high intensity or high energy external disturbances) such PEA systems can apply additional undesired disturbance on the PS. Those high energy regimes involve aggressive dynamical regimes of high accelerations and/or oscillation amplitudes. Therefore, there is a need in the industry to address one or more of these shortcomings.

### SUMMARY OF THE INVENTION

Embodiments of the present invention provide a hybrid rotational passive energy absorber. Briefly described, the present invention is directed to a hybrid impact passive energy absorber having a rigid housing with a mounting base. A housing body includes an interior chamber formed around a chamber axis spanning between two ends of the body. A chamber central portion is partially bounded by first and second central chamber walls. A first chamber end portion extends from the body first end and the first central chamber wall, and a second chamber end portion extends from the body second end and the second central chamber wall. A shaft is disposed within the housing chamber along the chamber axis between the housing first and second ends. An internal mass within the chamber central portion slides on the shaft passing through an internal mass central bore. First and second helical springs surround the shaft on either side of the internal mass, abutting both the chamber end and the internal mass.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1A is a schematic diagram of a first exemplary embodiment of a hybrid impact passive energy absorber.

FIG. 1B is a partial cutaway view of the diagram of FIG. 1A.

FIG. 2 is a schematic diagram of the dynamical system of FIG. 1A of a primary linear oscillator with the HI-PEA.

FIG. 3A is a schematic diagram of the first exemplary embodiment of FIG. 1A of a hybrid impact passive energy absorber with an internal mass (IM) fully displaced in a first direction.

FIG. 3B shows the HI-PEA of FIG. 3A with the IM in a neutral mid-position.

FIG. 3C shows the HI-PEA of FIG. 3A with the IM fully displaced in a second direction.

FIG. 4 is a schematic diagram shows a cutaway cross-section end view of the HI-PEA of FIG. 1A, to illustrate the concentric arrangements of the elements of the HI-PEA around the center axis 150 (FIG. 1A).

FIG. 5A is a schematic diagram of a second exemplary embodiment of a hybrid impact passive energy absorber with an internal mass (IM) fully extended in a first direction.

FIG. 5B shows the HI-PEA of FIG. 5A with the IM in a neutral mid-position.

FIG. 5C shows the HI-PEA of FIG. 5A with the IM fully extended in a second direction.

FIG. 6 is a flowchart of an exemplary embodiment of a method for mitigating vibration in a system.

FIG. 7A is a schematic drawing of the first embodiment of a system with an HI-PEA of FIG. 1B attached to a structure of interest from a front view.

FIG. 7B is a schematic drawing of the system of FIG. 7A a front view.

FIG. 7C is a schematic drawing of the system of FIG. 7A a side view.

FIG. 7D is a schematic drawing of the structure of interest of FIG. 7A deforming under a vibrational load.

FIG. 8 is a schematic cutaway drawing detailing a spring of the HI-PEA of FIG. 1B.

### DETAILED DESCRIPTION

The following definitions are useful for interpreting terms applied to features of the embodiments disclosed herein, and are meant only to define elements within the disclosure.

As used within this disclosure, “substantially” means very nearly, or to within typical manufacturing standards. For example, two substantially identical parts may be considered to be the same except for minor variations within accepted manufacturing tolerances.

As used within this disclosure, “oscillatory mode” refers to the response of the disclosed embodiments wherein an internal mass (IM) of the embodiment oscillates within a chamber without contacting walls of the chamber.

As used within this disclosure, “impacting mode” refers to the response of the disclosed embodiments wherein the IM of the embodiment oscillates within a chamber and impacts against walls of the chamber.

As used within this disclosure a “low-moderate energy loading” refers to a magnitude of excitation intensity that results in an oscillation mode but is insufficient to result in the impacting mode in the disclosed embodiments. In contrast when the external excitations are energetic enough, i.e. “high-energy loadings”, the IM 120 performs collisions with the internal walls 145a, 145b of the housing 110 for high energies. As such, low-moderate energy loading and high-energy loading are relative to the size (mass and dimensions) of the disclosed embodiments. Low energy loading is associated with external disturbances that lead to oscillations of the IM, and which are not sufficient for occurrence of collisions with the inner walls of the housing. Moderate energy loading is associated with large amplitude oscillations of the IM which lead to or almost lead to non-continuous impacts. High emerge loading refers to external disturbances which lead to continuous and abrupt collisions between the IM 120 and the inner walls 145a, 145b of the housing 110.

Reference will now be made in detail to embodiments of the present invention, examples of which are illustrated in the accompanying drawings. Wherever possible, the same reference numbers are used in the drawings and the description to refer to the same or like parts.

This disclosure describes exemplary embodiments of a Hybrid Impact PEA (HI-PEA) under the present invention. The embodiments hybridize the advantages of both a linear PEA, referred to herein as tuned mass damper (TMD), and a nonlinear PEA, referred to herein as nonlinear energy sink (NES). The HI-PEA combines the advantages of a TMD and a NES without suffering from their individual drawbacks.

For energy excitations that are small with respect to the movement range and mass of the HI-PEA, the HI-PEA responds with small oscillations, thereby behaving like a TMD. As described further below, when the system experiences high energy excitations with respect to the movement range and mass of the HI-PEA, collisions of the internal mechanisms of the HI-PEA with an internal rigid wall of the HI-PEA housing behave like an NES. Due to essential nonlinearity of the HI-PEA during collisions, the HI-PEA adopts the frequency of the excitation to resonate with the main system being protected. Thereby, the efficient energy transfer mechanism is utilized for both low and high energy excitations, i.e. for broad energy range, in contrast to TMD and NES.

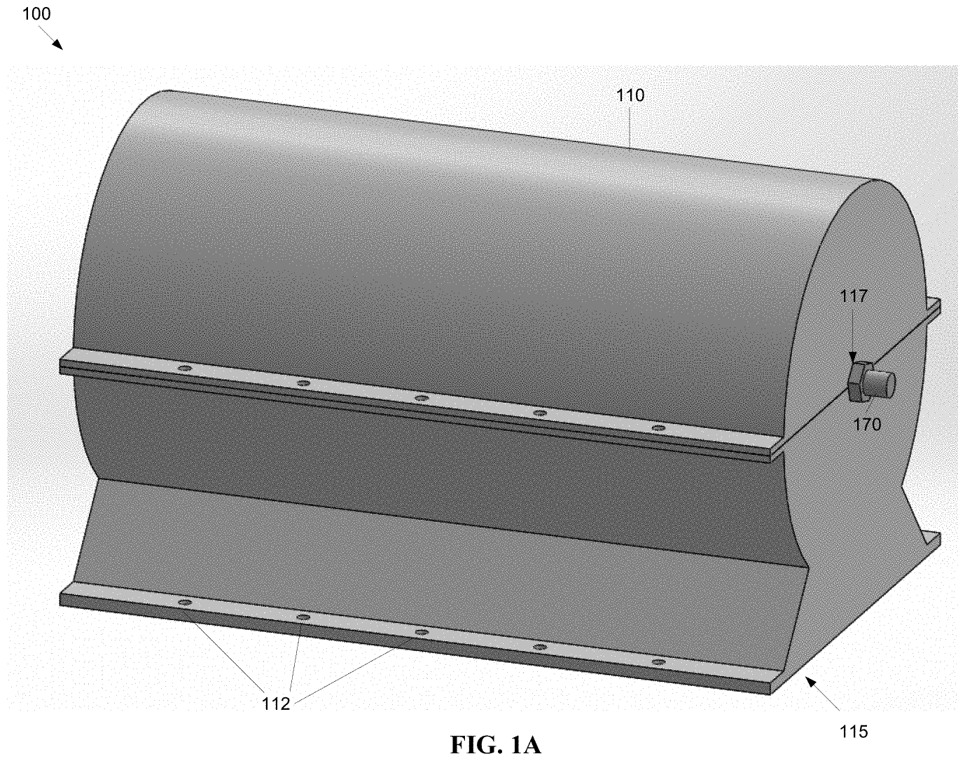

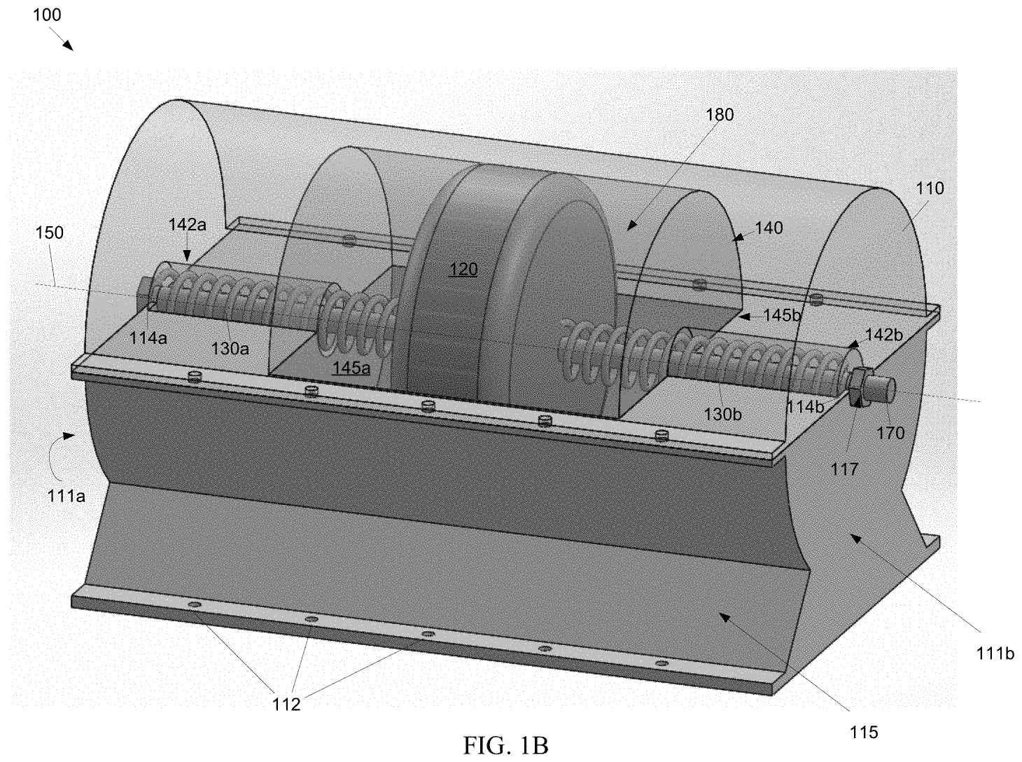

FIG. 1A is a schematic diagram of a first exemplary embodiment of a HI-PEA 100. The external part of the HI-PEA 100 is a housing 110, made from, for example, stainless steel or another rigid material which allows the housing 110 to withstand strong internal impacts and intense external disturbances. The housing 110 is attached to the main system, for example, via fasteners through interface holes 112 located in a bottom face of a base portion 115 of the housing 110.

FIG. 1B shows the schematic diagram of FIG. 1A with a portion of the housing 110 rendered transparent to reveal a moving mechanism 180 of the HI-PEA 100. An internal mass 120 (IM) made from a heavy material, for example brass is slidably mounted on a concentric shaft 170 spanning a housing first end 111a and a housing second end 111b, allowing the IM 120 to slide freely in one dimension along the concentric shaft 170. The concentric shaft 170 may be rigidly connected into the housing first end 111a and/or the housing second end 111b, for example by a fastener 117. A surface of the concentric shaft 170 may have a low friction coefficient, for example, with μ≤0.2, to facilitate the sliding motion of the IM 120 along the length of the concentric shaft 170. For example, the shaft 170 may be a long bolt, which is affixed and tightened to the housing 110 using a nut 117, among other fastening arrangements.

Two substantially identical helical springs 130a, 130b are arranged to surround surrounding the concentric shaft 170. A first helical spring 130a is located on a first side of the IM 120, located between the IM 120 and a first interior end wall 114a of the housing 110. Similarly, a second helical spring 130b is located on a second side of the IM 120, located between the IM 120 and a second interior end wall 114b of the housing 110 opposite the first interior end wall 114a.

The springs 130a, 130b are pre-compressed to prevent undesired backlash between components of the moving mechanism 180, namely the IM 120, the shaft 170, and the springs 130. For example, the springs 130a, 130b may be pre-compressed in such that when the IM 120 contacts one of the inner walls 145, the conjugate spring 130 reaches 95% of its uncompressed length.

The springs 130 allow the IM 120 to oscillate (linear PEA/TMD) when the main system the HI-PEA is attached to is exposed to low-moderate energy loading. When the external excitations are energetic enough, i.e. “high-energy loadings”, the IM 120 performs collisions with the internal walls 145a, 145b of the housing 110 and behaves as a NES. The former regime (oscillatory mode) leads to effect vibration mitigation for low and moderate energies and the latter (impact mode) for high energies.

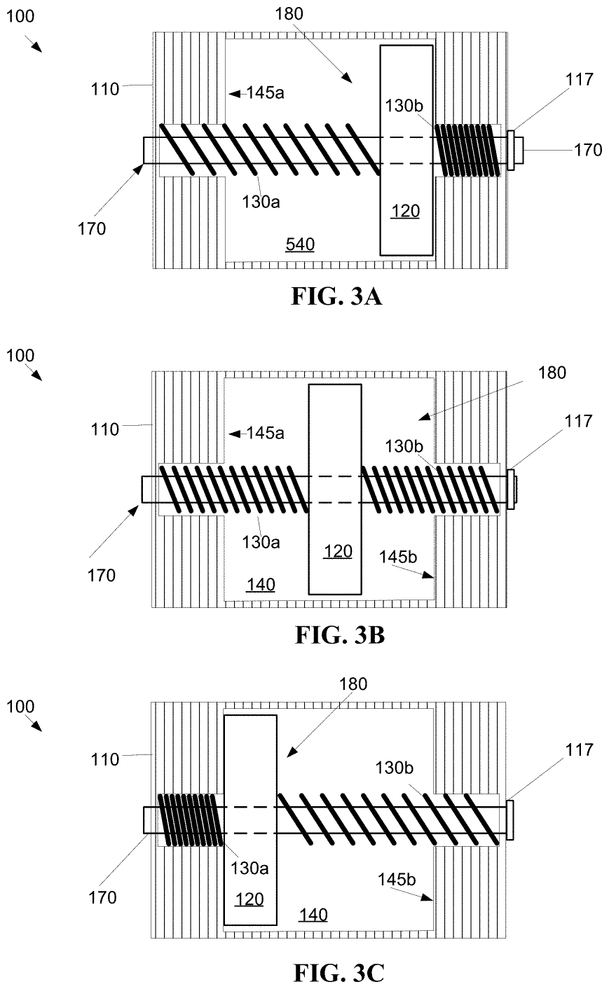

An axially oriented chamber within the housing 110 has three cylindrically shaped portions 140, 142a, 142b aligned with a central axis 150 of the HI-PEA 100 along the shaft 170. An inner diameter C_{DI} of a central chamber portion 140 may be slightly larger than an outer diameter IM_{DO} of the IM 120, allowing the IM 120 to slide along the shaft 170 within the center chamber portion 140 without contacting a cylindrically surrounding wall of the central chamber portion 140. In oscillatory mode, the IM 120 moves within the central chamber portion 140 without impacting central chamber end walls 145a, 145b. Each of the helical springs 130a, 130b abut the IM 120 and span from the IM 120 past the central chamber end walls 145a, 145b to abut the interior end walls 114a, 114b of the housing 110. An outer diameter HS_{DO} of a cross-section of the helical springs 130a, 130b is smaller than an inner diameter EC_{DI} of the end chambers 142a, 142b, so that the helical springs 130a, 130b may extend through their respective end chambers 142a, 142b both when expanded and compressed without the helical springs 130a, 130b contacting a cylindrical inner surface of the end chambers 142a, 142b. FIG. 3A shows the IM 120 fully displaced in a first direction. FIG. 3B shows the IM 120 in a neutral mid-position. FIG. 3C shows the IM 120 fully displaced in a second direction.

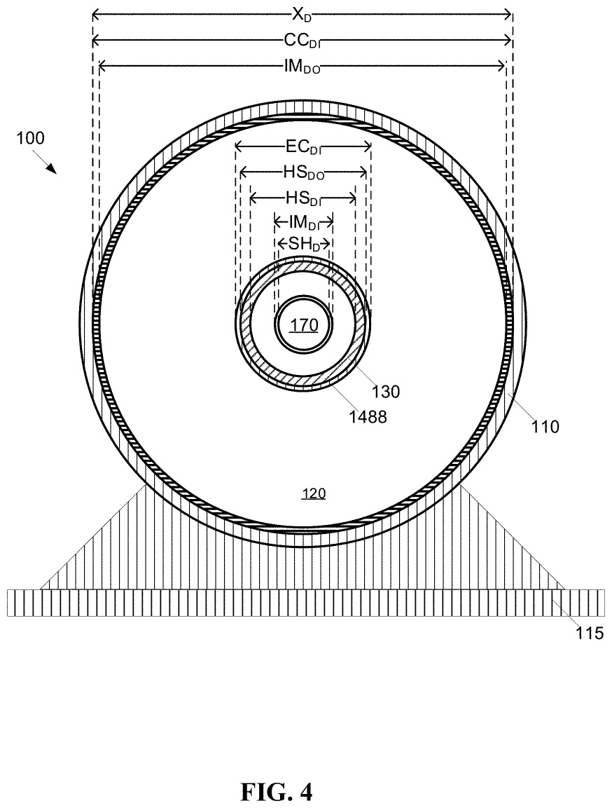

FIG. 4 shows a cutaway cross-section end view of the HI-PEA 100 of FIG. 1A, to illustrate the concentric arrangements of the elements of the HI-PEA around the center axis 150 (FIG. 1A). In order of size (small to large), the diameters of the concentric portions of the HI-PEA include:
Diameter of the shaft 170 SH_{D}
Diameter of a center axial aperture of the internal mass 120 IM_{DI}
Inner diameter of the helical springs 130a, 130b HS_{DI}
Outer diameter of the helical springs 130a, 130b HS_{DO}
Inner Diameter of the end chamber 142a, 142b EC_{DI}
Outer Diameter of the IM 120 IM_{DO}
Center Chamber portion 140 Inner Diameter C_{DI}
Housing Exterior Diameter X_{D}

In alternative embodiments, instead of two springs 130a, 130b, a single spring may be embedded within the IM 120 and extend equally outward from each side of the IM.

While the first embodiment HI-PEA 100 has a housing and moving mechanism components with a circular profile, in alternative embodiments the housing and moving mechanism may have profiles with different shapes.

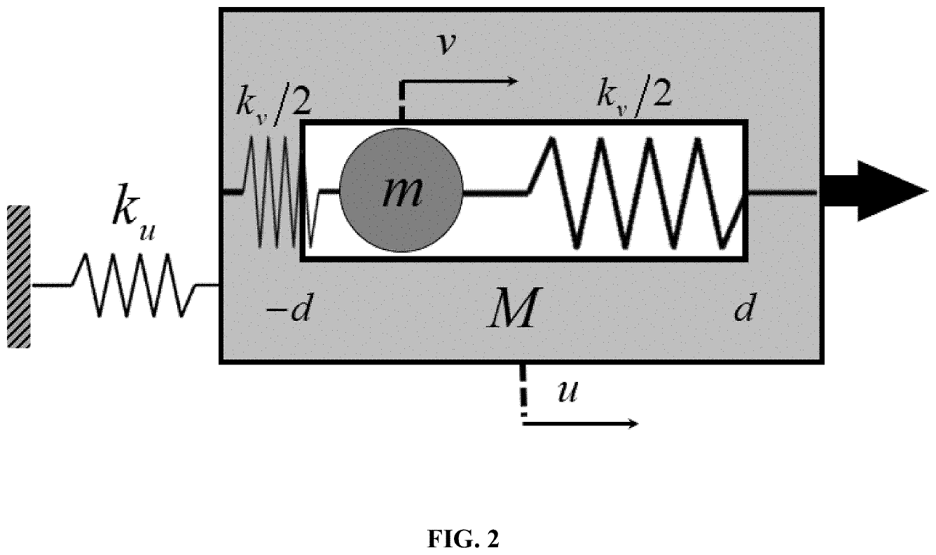

A mathematical model of the HI-PEA 100 includes a primary linear oscillator and the internal mass (IM) 120, which is located in a straight frictionless cavity 140 inside the primary structure (PS), which is a combined representation of both the main system and the housing of the HI-PEA. The length of the internal cavity is 2d. The mass of the PS is M and the mass of the internal mass 120 is m. The IM 120 is considered to be essentially smaller than the PS, so m<M. The rigidity of the linear spring of the PS is denoted by kᵤ; where damping of the linear spring is neglected in order to explore the IM 120 dynamical regimes and energy absorption efficiency in as rectified form as possible. The IM 120 is attached to the PS by two linear springs with total stiffness of kᵥ. The restitution coefficient is κ. Absolute dimensional displacements of PS and the IM 120 particle are denoted as u(t) and v(t), respectively. A sketch of the system is presented in FIG. 2.

The dimensional Lagrangian of the system is written as follows:

L(u,v)=½Mu′²+½mv′²−½kᵤu²−½kᵥ(u−v)² (Eq.1)

As one can see, the Lagrangian describes merely the non-impact terms of the system, while the non-smooth terms will be considered later. Let us introduce the relative non-dimensional displacement of the IM with respect to the PS, w(t):

$$w ( t ) = \frac{u ( t ) - v ( t )}{d} \qquad ( Eq . 2 )$$

Impact occurs when |w(tⱼ)|=1, where tⱼ is the instance of the j^{th} impact. In the current study, we adopt the traditional approach of instantaneous Newtonian impact, in which the velocity of the impacting particle changes according to the following rule:

w′(tⱼ⁺)=−κw′(tⱼ⁻) (Eq. 3)

Here tⱼ⁻ and tⱼ⁺ denote the time instances immediately before and after the j^{th} impact, respectively. Momentum conservation in vicinity of the impact instance yields the following relation:

Mu′(tⱼ⁺)+mv′(tⱼ⁺)=Mu′(tⱼ⁻)+mv′(tⱼ⁻) (Eq. 4)

From Eq. 2-4, the momentum transfers from the PS to the internal mass in each collision is given by the following expression:

$$Δ P = M ( {u}^{′} ( {t}_{j}^{+} ) - {u}^{′} ( {t}_{j}^{-} ) ) = - d \frac{Mm}{M + m} ( κ + 1 ) {w}^{′} ( {t}_{j}^{-} ) \qquad ( Eq . 5 )$$

Hence, from the Lagrangian shown in Eq. 1, the equations of motion are obtained as follows:

$${Mu}^{″} + {k}_{u} u + {k}_{v} ( u - v ) + d \frac{mM}{M + m} ( κ + 1 ) {\sum }_{j} {w}^{′} ( {t}_{j}^{-} ) δ ( t - {t}_{j} ) = 0 \\ {mv}^{″} - {k}_{v} ( u - v ) - d \frac{mM}{M + m} ( κ + 1 ) {\sum }_{j} {w}^{′} ( {t}_{j}^{-} ) δ ( t - {t}_{j} ) = 0 \qquad ( Eq . 6 )$$

Here, δ(t) is the Dirac delta function. Equation (6), and subsequent equations containing delta-functions, should be understood in the sense of distributions. Functions u(t) and v(t) are sought in a class of everywhere continuous and piecewise smooth functions. Time derivatives exhibit discontinuity at the impact time instances.

We describe the dynamics using the displacement of the system's center of mass, R(t). In this manner, the impact term will vanish in the one of the equations of motion.

$$R ( t ) = \frac{Mu ( t ) + mv ( t )}{d ( M + m )} \qquad ( Eq . 7 )$$

From this point, dot represents differentiation with respect to non-dimensional time τ=ω_{R}t. The coordinate transformation of Eq. 8 is implemented using Eq. 2 and Eq. 7 to obtain the following transformed non-dimensional equations of motion with respect to coordinates R and w, and non-dimensional time τ:

$$\ddot{R} + R + \frac{ɛ}{1 + ɛ} w = 0 \\ \ddot{w} + {β}^{2} w + ( 1 + ɛ ) R + ( κ + 1 ) {\sum }_{j} \dot{w} ( {τ}_{j}^{-} ) δ ( τ - {τ}_{j} ) = 0 \qquad ( Eq . 8 )$$

Here ε=m/M□1 (epsilon equals to m divided by M, essentially smaller than 1) is the IM and PS mass ratio, which is considered to be a small parameter, as explained above. β=ω_{w}/ω_{R} is frequency ratio of order of unity, where ω_{R}²=ωᵤ²/(1+ε) and ω_{w}²=(1+ε)(ωᵥ²+εω_{M}²/(1+ε)²) are the natural frequencies of the transformed system of equations, and ωᵤ=\sqrt{kᵤ/M} and ωᵥ=\sqrt{kᵥ/M} are the natural frequencies of the system before the transformation. All frequencies are of order unity.

Forward analysis considers impulsive loading on the primary structure, where all initial displacements and velocities equal to zero, except \dot{u}₀=\sqrt{2E₀}; E₀ is the initial energy of the system.

Comparison of the absorption performance of HI-PEA, NES and TMD for high-energy excitation is shown in FIG. 3. As one can see, the HI-PEA outperforms both TMD and NES in terms of energy absorption performances, absorbing 80% of the energy from the main system after only 2 seconds from the beginning of the high-energy excitation.

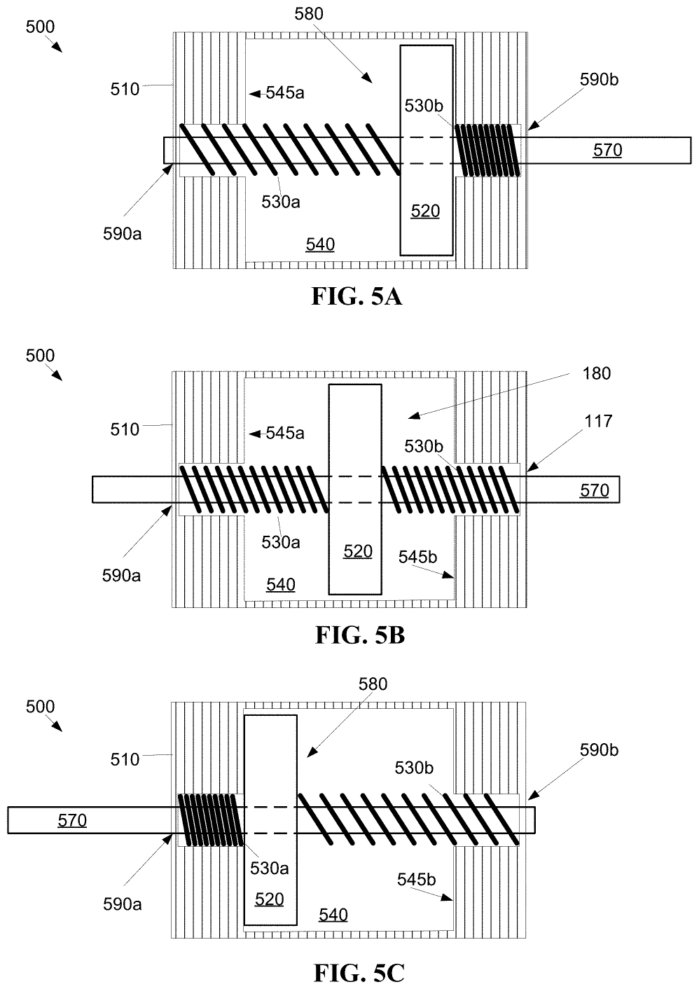

FIGS. 5A-5C show a second exemplary embodiment of a HI-PEA 500. Under the second embodiment, a housing 510 encloses a moving mechanism 580 including a central shaft 570, an internal mass (IM) 520. Two helical springs 530a, 530b are configured to surround the central shaft 570 on either side of the IM 520. In contrast to the first embodiment HI-PEA 100, under the second embodiment HI-PEA 500 the IM is non-slidably affixed to the central shaft 570, such that the IM 530 and central shaft 570 uniformly slide in a one dimensional path within the housing 510. The sliding of the moving mechanism may be facilitated, for example, by bearings 590a, 590b located at either end of the housing 510. As with the first embodiment, a central chamber 540 has end walls 545a, 545b that confine the movement of the IM 520 within the central chamber 540.

The springs 530a, 530b are pre-compressed (in the manner described above regarding the first embodiment), to prevent undesired backlash between components of the moving mechanism 580, namely the IM 520, and the shaft 570. The springs 530 allow the internal mass 520 to oscillate (linear PEA/TMD) when the main system the HI-PEA is attached to is exposed to low-moderate energy loading, and to collide with the internal walls 545a, 545b of the housing 510 for high energies (NES). The former regime (oscillatory mode) leads to effect vibration mitigation for low and moderate energies and the latter (impact mode) for high energies.

FIG. 5A shows the IM 520 fully extended in a first direction. FIG. 5B shows the IM 520 in a neutral mid-position. FIG. 5C shows the IM 520 fully extended in a second direction. While FIGS. 5A-5C show the central shaft extending outward past the ends of the housing 510, in alternative embodiments the housing 510 may be elongated in a fashion to retain the central shaft 570 entirely within the housing over a full range of motion of the central shaft 570.

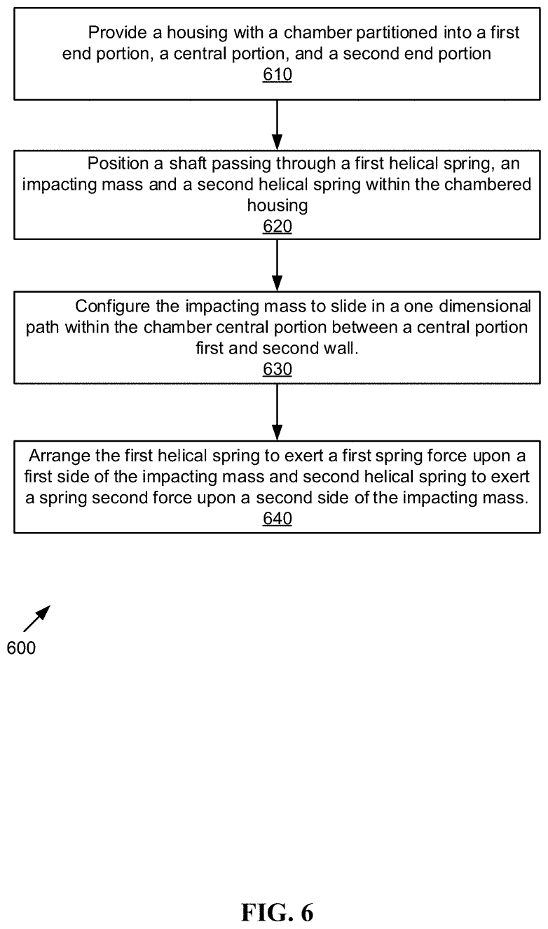

FIG. 6 is a flowchart of an exemplary embodiment of a method for mitigating vibration in a system. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention. The method is described with respect to FIG. 1B.

A housing 110 with a chamber partitioned into a first end portion 142a, a central portion 140, and a second end portion 142b is provided, as shown by block 610. A movable mechanism 180 having a first helical spring 130a, a second helical spring 130b, an internal mass 120, and a shaft 170 passing through the first helical spring, the internal mass, and the second helical spring is positioned within the chambered housing, as shown by block 620. The internal mass is configured to slide in a one-dimensional path within the chamber central portion between a central portion first wall and a central portion second wall, as shown by block 630. The first helical spring is arranged to exert a first spring force upon a first side of the internal mass, and the second helical spring is arranged to exert a spring second force upon a second side of the internal mass, as shown by block 640. The second spring force is substantially equal to the first spring force when the internal mass is located at a midpoint of the chamber central portion.

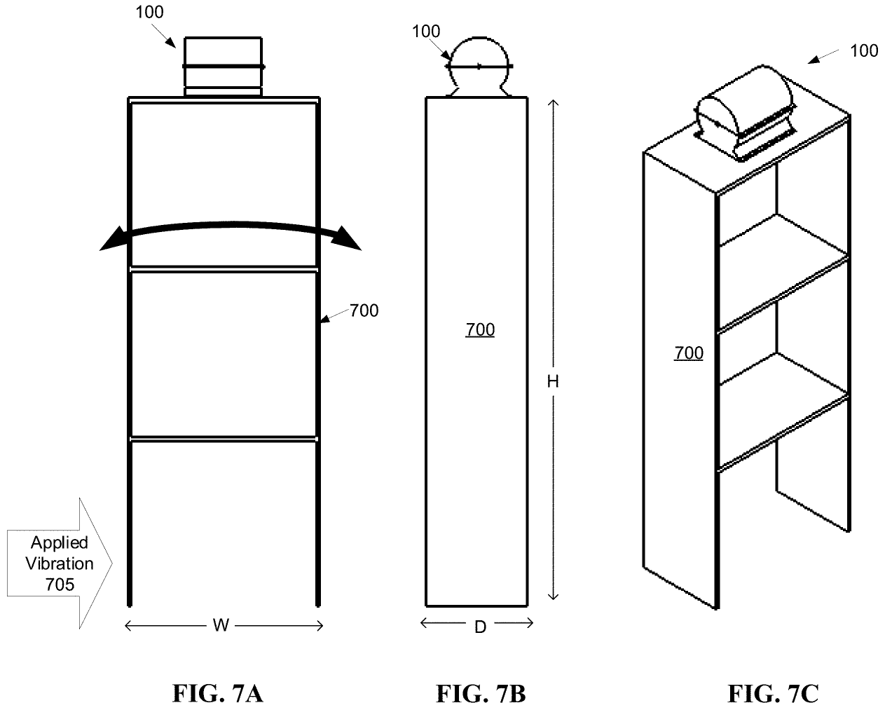

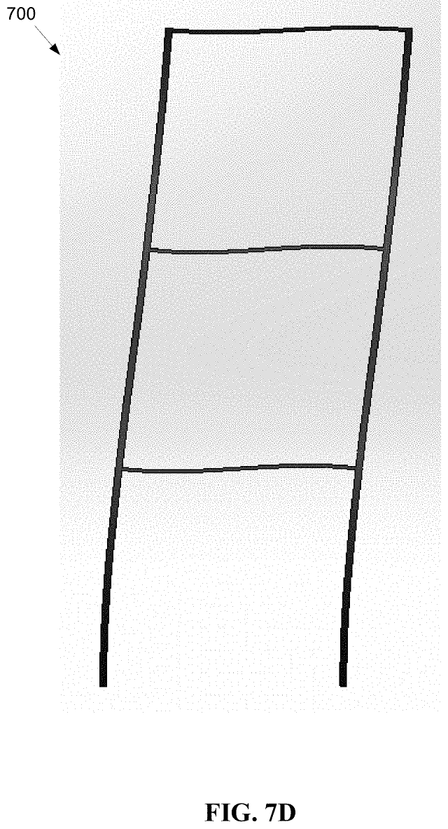

For non-limiting exemplary purposes only, FIGS. 7A-7D show a specific example applying the above model to the embodiment of the HI-PEA 100 of FIG. 1B. The absorption performances of the HI-PEA 100 are demonstrated by attaching the exemplary HI-PEA 100 to a PS 700, here a multi-story structure 700, as shown by FIGS. 7A-7C. The height H of the exemplary PS 700 is 2000 mm, the width W is 750 mm, the depth D is 400 mm. The thickness of each story is 20 mm, and the thickness of the external beams is 11 mm. As shown in FIGS. 7A-7C, the structure contains three stories with identical heights. The structure 700 is made of 304 stainless steel with a density of ρ=8000 kg/m³ and module of elasticity of E=190 GPa. The foundations of the PS 700 are securely fixed to the ground, for example by welding. The mass of the PS 700 is 280.58 kg, and the natural frequency of the PS 700 that corresponds to the undesired oscillatory mode is f=6.45 Hz. Here, the HI-PEA 100 is mounted to the highest story of the PS 700, where motion of the PS 700 as a result of an applied vibration 705 is of the largest amplitude, i.e. highest vibration energy, as indicated by the thick black arrow shown in FIG. 7A.

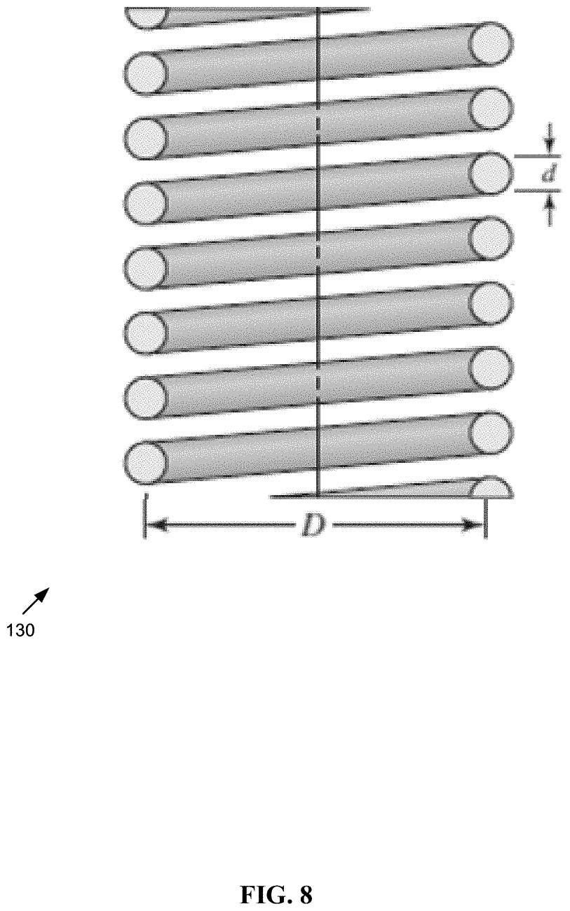

The IM 120 (FIG. 1B) is made of brass with density ρ=8730 kg/m³ to allow low friction with the sliding bar (which is made of stainless steel) of approximately μ=0.15. The mass of the dimensions of the IM 120 were chosen to obtain mass of 10% with respect of the PS, of diameter Dₘ=200 mm and width of wₘ=100 mm. Hence, the mass of the IM is m=27.42 kg. The spiral compression springs 130a, 130b were chosen to yield identical frequency as the frequency that corresponds to the first bending mode of the structure, i.e. f=6.45 Hz (when the bottom of the PS 700 is fixes to the floor (not shown)). The spring coefficient of spiral compression spring is per Eq. 9

$$k = \frac{{d}^{4} G}{8 {D}^{3} N} \qquad ( Eq . 9 )$$

where d, G, D and N are the diameter of the wire diameter, shear modulus, coil diameter and number of coils of the springs 130a, 130b, as shown in FIG. 8. The natural frequency of the IM 120 is determined by Eq. 10:

$${f}_{m} = \sqrt{\frac{2 k}{m}} \qquad ( Eq . 10 )$$

The example of FIGS. 7A-7D use a spring wire made of 302 stainless steel, with shear modulus of G=77.2 GPa and density of ρ=7860 kg/m³. The resulting natural frequency of the IM is fₘ=6.45 Hz. For the sake of demonstration, the PS 700 was subjected to impulsive ground loading applied on the foundations of the PS which corresponds to a nonzero initial velocity. FIG. 7D shows a snapshot in time of the PS 700 in a deformed state under an active vibration mode for mitigation.

Examples of applications for the embodiments described above include (but are not limited to):
Aerial systems
Machinery with rotating elements
Earthquakes
Vehicle accidents, and more.

It will be apparent to those skilled in the art that various modifications and variations can be made to the structure of the present invention without departing from the scope or spirit of the invention. For example, while the embodiments refer to helical springs, other functionally equivalent springs may be used in alternative embodiments. In view of the foregoing, it is intended that the present invention cover modifications and variations of this invention provided they fall within the scope of the following claims and their equivalents.

What is claimed is:

1. A hybrid impact passive energy absorber (100), comprising:
a rigid housing (110) comprising:
a mounting base; and
a body affixed to the mounting base further comprising a first end (111a), a second end (111b) opposite the first end, a contiguous chamber within the body formed around a chamber axis spanning the first end and the second end, wherein the chamber further comprises:
a chamber central portion (140) partially bounded by a first central chamber wall (145a) and a second chamber wall (145b);
a first chamber end portion bounded by the body first end and the first central chamber wall; and
a second chamber end portion bounded by the body second end and the second central chamber wall;
a shaft (170) comprising a first end and a second end, the shaft disposed at least partially within the housing chamber along the chamber axis between the housing first end and housing second end;
an internal mass (120) comprising a central bore configured to receive the shaft therethrough, the internal mass disposed within the chamber central portion between the first central chamber wall and the second central chamber wall;
a first helical spring (130a) surroundingly disposed upon the shaft between and abutting both the chamber first end and a first side of the internal mass; and
a second helical spring (130b) surroundingly disposed upon the shaft between and abutting both the chamber second end and a second side of the internal mass.

2. The hybrid impact passive energy absorber of claim 1, wherein the first chamber wall (145a) and the second chamber wall (145b) are arranged to physically retain the internal mass within the chamber central portion.

3. The hybrid impact passive energy absorber of claim 1, wherein the first helical spring is substantially identical to the second helical spring.

4. The hybrid impact passive energy absorber of claim 3, wherein, when the internal mass is positioned at a midpoint between the first chamber wall and the second chamber wall, the first helical spring and the second helical spring are each partially compressed and are each exerting a force upon the internal mass.

5. The hybrid impact passive energy absorber of claim 1, wherein:
the first end of the shaft is affixed to the housing first end;
the second end of the shaft is affixed to the housing second end; and
the internal mass is configured to slide along the shaft.

6. The hybrid impact passive energy absorber of claim 1, wherein:
the first end of the shaft is configured to slide through a first aperture in the housing first end;
the second end of the shaft is configured to slide through a second aperture in the housing second end; and
the internal mass is rigidly affixed to the shaft at a shaft midpoint.

7. The hybrid impact passive energy absorber of claim 1, further comprising means to affix the mounting base to an external mass.

8. A method for mitigating vibration in a system having a first mass, comprising the steps of:
providing a housing comprising a chamber partitioned into a first end portion, a central portion, and a second end portion;
positioning a movable mechanism comprising a first helical spring, a second helical spring, an internal mass, and a shaft passing through the first helical spring, the internal mass, and the second helical spring within the chambered housing;
configuring the internal mass to slide in a one dimensional path within the chamber central portion between a central portion first wall and a central portion second wall;
arranging the first helical spring to exert a first spring force upon a first side of the internal mass;
arranging the second helical spring to exert a spring second force upon a second side of the internal mass, wherein the second spring force is substantially equal to the first spring force when the internal mass is located at a midpoint of the chamber central portion;
wherein a combined mass of the chambered housing and the movable mechanism is less than the first mass.

9. The method of claim 8, wherein a mass of the internal mass, the first force and the second force are selected so the internal mass oscillates within the chamber central portion without impacting the central portion first wall and the central portion second wall in response to an applied first external force.

10. The method of claim 9, wherein a mass of the internal mass, the first force and the second force are selected so the internal mass impacts the central portion first wall and/or the central portion second wall in response to an applied second external force greater than the first external force.

11. The method of claim 10, further comprising the step of affixing the housing to the system.
